(19) United States
(12) Patent Application Publication
(10) Pub. No.: US 2022/0382463 A1
(43) Pub. Date: Dec. 1, 2022

(54) INFORMATION PROCESSING APPARATUS, INFORMATION PROCESSING METHOD, AND INFORMATION PROCESSING PROGRAM

(71) Applicant: FUJIFILM CORPORATION, Tokyo (JP)

(72) Inventors: Michitaka KONDO, Tokyo (JP); Yutaka OISHI, Tokyo (JP); Takashi MIYAMOTO, Tokyo (JP); Terue WATANABE, Tokyo (JP); Koji MATSUMURA, Tokyo (JP); Yuko UNO, Tokyo (JP)

(21) Appl. No.: 17/818,715

(22) Filed: Aug. 10, 2022

Related U.S. Application Data
(63) Continuation of application No. PCT/JP2021/000905, filed on Jan. 13, 2021.

(30) Foreign Application Priority Data
Feb. 28, 2020 (JP) 2020-034302

(51) Int. Cl. G06F 3/06

(52) U.S. Cl. CPC G06F 3/0617; G06F 3/0667; G06F 3/0682

(57) ABSTRACT

An information processing apparatus calculates, in a case where an object including at least one of data or metadata related to the data is recorded in a magnetic tape including a first partition in which one or more objects are to be recorded and a second partition in which pieces of the metadata are to be recorded, a second ratio as a ratio between a size of the first partition and a size of the second partition in the magnetic tape by using a first ratio as a ratio between a total size of the objects and a total size of the pieces of the metadata.

### CROSS-REFERENCE TO RELATED APPLICATIONS

This application is a continuation application of International Application No. PCT/JP2021/000905, filed Jan. 13, 2021, the disclosure of which is incorporated herein by reference in its entirety. Further, this application claims priority from Japanese Patent Application No. 2020-034302, filed on Feb. 28, 2020, the disclosure of which is incorporated herein by reference in its entirety.

### BACKGROUND

### 1. Technical Field

The present disclosure relates to an information processing apparatus, an information processing method, and an information processing program.

### 2. Description of the Related Art

JP2015-69290A discloses a magnetic tape including a data partition in which data is to be recorded and an index partition in which an index related to the data is to be recorded. JP2015-69290A discloses a technique of setting a size of the index partition to 5% of a size of the entire magnetic tape.

### SUMMARY

On the other hand, as described in JP2015-69290A, a recent magnetic tape may be divided into partitions, for example, a first partition in which data is to be recorded and a second partition in which metadata related to the data is to be recorded.

In general, a size of the data varies depending on the data. On the other hand, a size of the metadata does not depend on the data, and has a small variation compared to the size of the data. For this reason, when recording a set of the metadata and the data in a magnetic tape, in a case where the data is recorded in the first partition and the metadata is recorded in the second partition regardless of the size of the data, the following problems may occur.

For example, in a case where only the data having a relatively large size is recorded in the first partition, even though a free capacity exists in the second partition and the metadata can be recorded in the second partition, in some cases, a free capacity does not exist in the first partition, and as a result, the data cannot be recorded in the first partition. On the other hand, in a case where only the data having a relatively small size is recorded in the first partition, even though a free capacity exists in the first partition and the data can be recorded in the first partition, in some cases, a free capacity does not exist in the second partition, and as a result, the metadata cannot be recorded in the second partition. In these cases, even though a free capacity exists in any one of the partitions, a free capacity does not exist in the other of the partitions. As a result, a set of the metadata and the data cannot be recorded in the magnetic tape. Thus, the magnetic tape cannot be efficiently used.

The present disclosure has been made in view of the above circumstances, and an object of the present disclosure is to provide an information processing apparatus, an information processing method, and an information processing program capable of efficiently using a magnetic tape.

According to an aspect of the present disclosure, there is provided an information processing apparatus including: at least one processor, in which the processor is configured to, in a case where an object including at least one of data or metadata related to the data is recorded in a magnetic tape including a first partition in which one or more objects are to be recorded and a second partition in which pieces of the metadata are to be recorded, calculate a second ratio as a ratio between a size of the first partition and a size of the second partition in the magnetic tape by using a first ratio as a ratio between a total size of the objects and a total size of the pieces of the metadata.

In the information processing apparatus according to the aspect of the present disclosure, the first ratio may be a ratio between the total size of the objects after compression and the total size of the pieces of the metadata after compression.

Further, in the information processing apparatus according to the aspect of the present disclosure, the processor may be configured to, in a case where one storage pool includes a plurality of the magnetic tapes, calculate the second ratio in the magnetic tape to be added to the storage pool such that the second ratio in the entire storage pool is set to the first ratio.

Further, in the information processing apparatus according to the aspect of the present disclosure, the processor may be configured to, in a case where the object is recorded in a storage pool including magnetic tapes formatted according to the second ratio, perform control of selecting one magnetic tape according to the first ratio from the storage pool and recording the object in the selected magnetic tape.

Further, in the information processing apparatus according to the aspect of the present disclosure, the first ratio may be a ratio between an average size of the objects and an average size of the pieces of the metadata, the average sizes being calculated from previous log data.

Further, in the information processing apparatus according to the aspect of the present disclosure, the average size of the objects and the average size of the pieces of the metadata may be average values obtained by weighted averages using weight coefficients having larger values as the object and the metadata are closer to current log data.

Further, in the information processing apparatus according to the aspect of the present disclosure, the processor may be configured to classify an object group to be recorded in the magnetic tape into a plurality of groups based on the first ratio and calculate the second ratio using the first ratio for each classified group.

Further, in the information processing apparatus according to the aspect of the present disclosure, the processor may be configured to classify the object group into a plurality of groups in a case where a variance value of the first ratio of the object group is equal to or larger than a predetermined threshold value and calculate the second ratio using the first ratio for each classified group.

Further, according to another aspect of the present disclosure, there is provided an information processing method executed by a processor of an information processing apparatus, the method including: calculating, in a case where an object including at least one of data or metadata related to the data is recorded in a magnetic tape including a first partition in which one or more objects are to be recorded and a second partition in which pieces of the metadata are to be recorded, a second ratio as a ratio between a size of the first partition and a size of the second partition in the magnetic tape by using a first ratio as a ratio between a total size of the objects and a total size of the pieces of the metadata.

Further, according to still another aspect of the present disclosure, there is provided an information processing program causing a processor of an information processing apparatus to execute a process including: calculating, in a case where an object including at least one of data or metadata related to the data is recorded in a magnetic tape including a first partition in which one or more objects are to be recorded and a second partition in which pieces of the metadata are to be recorded, a second ratio as a ratio between a size of the first partition and a size of the second partition in the magnetic tape by using a first ratio as a ratio between a total size of the objects and a total size of the pieces of the metadata.

According to the present disclosure, the magnetic tape can be efficiently used.

### BRIEF DESCRIPTION OF THE DRAWINGS

FIG. 1 is a block diagram illustrating an example of a configuration of a recording and reproducing system according to a first embodiment.

FIG. 2 is a diagram for explaining an object.

FIG. 3 is a schematic diagram illustrating an example of a magnetic tape.

FIG. 4 is a block diagram illustrating an example of a hardware configuration of an information processing apparatus according to the first embodiment.

FIG. 5 is a diagram illustrating an example of a write log.

FIG. 6 is a block diagram illustrating an example of a functional configuration of the information processing apparatus according to the first embodiment.

FIG. 7 is a diagram for explaining calculation processing by a calculation unit according to the first embodiment.

FIG. 8 is a flowchart illustrating an example of format processing of the magnetic tape according to the first embodiment.

FIG. 9 is a block diagram illustrating an example of a configuration of a recording and reproducing system according to a second embodiment.

FIG. 10 is a block diagram illustrating an example of a hardware configuration of an information processing apparatus according to the second embodiment.

FIG. 11 is a diagram illustrating an example of a pool management table.

FIG. 12 is a block diagram illustrating an example of a functional configuration of the information processing apparatus according to the second embodiment.

FIG. 13 is a diagram for explaining calculation processing by a calculation unit according to the second embodiment.

FIG. 14 is a diagram illustrating an example of an updated pool management table.

FIG. 15 is a flowchart illustrating an example of format processing of the magnetic tape according to the second embodiment.

FIG. 16 is a diagram for explaining processing of recording an object in a storage pool according to the second embodiment.

FIG. 17 is a schematic diagram for explaining an order of recording data and metadata according to a modification example.

### DETAILED DESCRIPTION

Hereinafter, an example of an embodiment for performing a technique of the present disclosure will be described in detail with reference to the drawings.

### First Embodiment

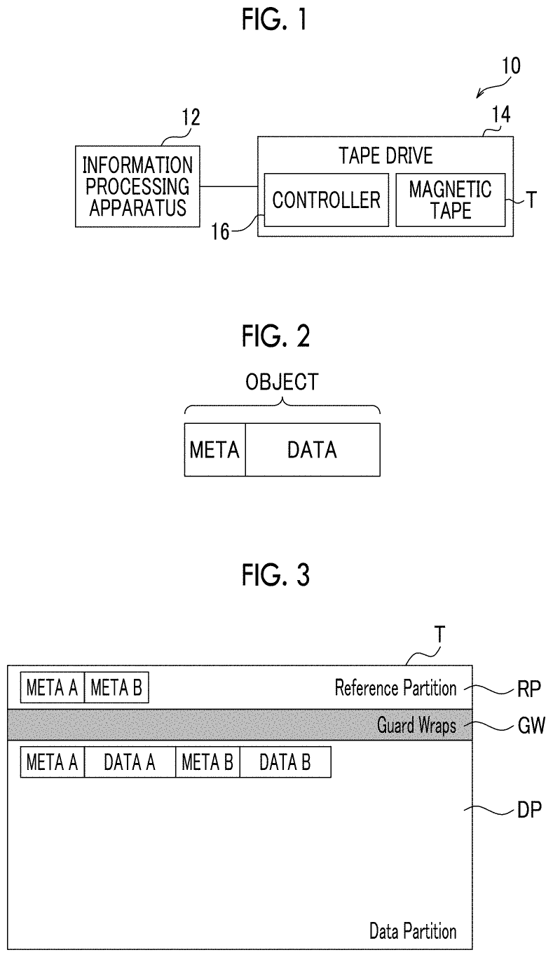

First, a configuration of a recording and reproducing system 10 according to the present embodiment will be described with reference to FIG. 1. As illustrated in FIG. 1, the recording and reproducing system 10 includes an information processing apparatus 12 and a tape drive 14. The tape drive 14 is connected to the information processing apparatus 12.

The tape drive 14 includes a magnetic tape T as an example of a recording medium. Further, the tape drive 14 includes a controller 16 including a processor such as a programmable logic device (PLD). The controller 16 performs control such as recording or reproducing of data to or from the magnetic tape T included in the tape drive 14. Here, recording of data means writing of data, and reproducing of data means reading of data. Further, examples of the magnetic tape T include a linear tape-open (LTO) tape.

In the present embodiment, in a case where the controller 16 records data in the magnetic tape T, the controller 16 records the data as a recording target in a compressed state. Further, in a case where data recorded in the magnetic tape T is reproduced, the controller 16 reads the data in a compressed state from the magnetic tape T, decompresses the data, and then outputs the data to the information processing apparatus 12.

In the present embodiment, as an example, as illustrated in FIG. 2, as a format of data to be recorded in the magnetic tape T, an example of an embodiment in which an object including data to be saved by a user such as document data and image data and metadata related to the data is applied will be described. In the example of FIG. 2, the metadata is referred to as “meta”. A storage system that handles such an object is called an object storage system. The metadata includes, for example, object identification information such as an object identifier (ID), data identification information such as a data name, a size of data, and attribute information such as a time stamp.

Next, a configuration of the magnetic tape T according to the present embodiment will be described with reference to FIG. 3. As illustrated in FIG. 3, in a case where the magnetic tape T is formatted, the magnetic tape T is divided into two partitions, a reference partition RP in which the metadata is to be recorded and a data partition DP in which the object is to be recorded. As illustrated in FIG. 3, in the present embodiment, in a case where an object is recorded in the data partition DP, the object is recorded in order of the metadata and the data. Further, the reference partition RP and the data partition DP are separated by guard wraps GW including a plurality of wraps. The data partition DP is an example of a first partition according to the technique of the present disclosure, and the reference partition RP is an example of a second partition according to the technique of the present disclosure. In the object group recorded in the data partition DP of the magnetic tape T, an object including only the data among the data and the metadata may exist, or an object including only the metadata among the data and the metadata may exist.

In general, a size of the data varies depending on the data. On the other hand, a size of the metadata does not depend on the data, and has a small variation compared to the size of the data. For this reason, in the magnetic tape T, in a case where a ratio between a size of the data partition DP and a size of the reference partition RP is set to a fixed value, there are the following problems.

For example, a case where a ratio of the size of the data partition DP to the size of the reference partition RP is 98:2 is considered. In this case, it is assumed that an average size of the object to be recorded in the magnetic tape T after being compressed is 2 KB for the metadata and 8 KB for the data (that is, the size of the metadata is 20% of the size of the object). In this case, when pieces of the metadata are recorded in the entire reference partition RP, the objects are recorded in the data partition DP by only approximately 10%. That is, although the object may further be recorded in the data partition DP, the metadata cannot be recorded in the reference partition RP. As a result, a new object cannot be recorded in the magnetic tape T.

On the other hand, it is assumed that an average size of the object to be recorded in the magnetic tape T after being compressed is 2 KB for the metadata and 998 KB for the data (that is, the size of the metadata is 0.2% of the size of the object). In this case, when the objects are recorded in the entire data partition DP, pieces of the metadata are recorded in the reference partition RP by only approximately 10%. That is, although the metadata may further be recorded in the reference partition RP, the object cannot be recorded in the data partition DP. As a result, a new object cannot be recorded in the magnetic tape T.

In these cases, the magnetic tape T cannot be efficiently used. For this reason, in the present embodiment, from tendencies of the size of the object and the size of the metadata, the object and the metadata being handled by the system, a ratio between the size of the data partition DP and the size of the reference partition RP is appropriately obtained. Thereby, it is possible to efficiently use the magnetic tape T. Note that this problem may also occur even in a case where a variation in the size of the data is smaller than a variation in the size of the metadata.

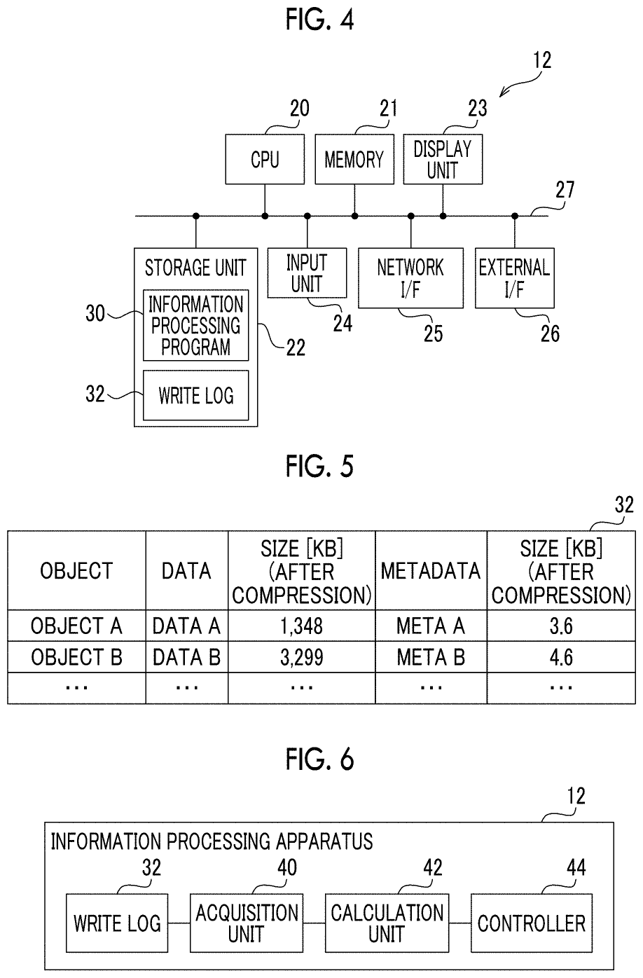

Next, a hardware configuration of the information processing apparatus 12 according to the present embodiment will be described with reference to FIG. 4. As illustrated in FIG. 4, the information processing apparatus 12 includes a central processing unit (CPU) 20, a memory 21 as a temporary memory area, and a non-volatile storage unit 22. Further, the information processing apparatus 12 includes a display unit 23 such as a liquid crystal display, an input unit 24 such as a keyboard and a mouse, a network interface (I/F) 25 connected to a network, and an external I/F 26 to which the tape drive 14 is connected. The CPU 20, the memory 21, the storage unit 22, the display unit 23, the input unit 24, the network I/F 25, and the external I/F 26 are connected to a bus 27.

The storage unit 22 is realized by a hard disk drive (HDD), a solid state drive (SSD), a flash memory, or the like. An information processing program 30 is stored in the storage unit 22 as a storage medium. The CPU 20 reads the information processing program 30 from the storage unit 22, develops the read information processing program 30 in the memory 21, and executes the developed information processing program 30. Examples of the information processing apparatus 12 include a server computer and the like.

Further, the storage unit 22 stores a write log 32 as previous log data. FIG. 5 illustrates an example of the write log 32. As illustrated in FIG. 5, in the write log 32, a size of the data compressed by the controller 16 and a size of the metadata compressed by the controller 16 are recorded for each object previously-recorded in the magnetic tape T of the recording and reproducing system 10. The size of the data compressed by the controller 16 and the size of the metadata compressed by the controller 16 correspond to a size of the data and a size of the metadata in the magnetic tape. Further, a total value of the size of the data and the size of the metadata corresponds to the size of the object.

Next, a functional configuration of the information processing apparatus 12 according to the present embodiment will be described with reference to FIG. 6. As illustrated in FIG. 6, the information processing apparatus 12 includes an acquisition unit 40, a calculation unit 42, and a controller 44. In a case where the CPU 20 executes the information processing program 30, the information processing apparatus 12 functions as the acquisition unit 40, the calculation unit 42, and the controller 44.

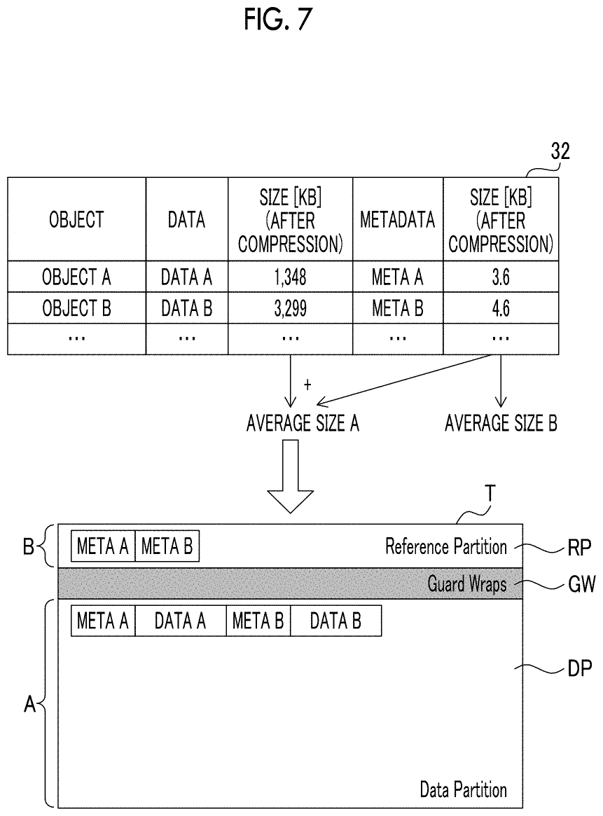

The acquisition unit 40 acquires the write log 32 from the storage unit 22. The calculation unit 42 calculates a second ratio as a ratio between the size of the data partition DP and the size of the reference partition RP in the magnetic tape T, by using a first ratio as a ratio between a total size of the objects and a total size of pieces of the metadata. Specifically, as illustrated in FIG. 7, the calculation unit 42 calculates an average size A of the objects and an average size B of pieces of the metadata, from the write log 32 acquired by the acquisition unit 40.

Further, the calculation unit 42 calculates a second ratio as a ratio between the size of the data partition DP and the size of the reference partition RP, by using a first ratio as a ratio between the calculated average size A and the calculated average size B. Specifically, as illustrated in FIG. 7, the calculation unit 42 sets the first ratio (=A:B) as the second ratio. The calculation unit 42 may calculate the average size A of the objects and the average size B of pieces of the metadata by weighted averages using weight coefficients having larger values as the object and the metadata are closer to the current log data in the write log 32. In this case, the first ratio in which a latest tendency is better reflected can be calculated.

The controller 44 performs control of setting the ratio between the size of the data partition DP and the size of the reference partition RP in the magnetic tape T included in the tape drive 14 to the second ratio calculated by the calculation unit 42. Specifically, the controller 44 outputs, to the controller 16 of the tape drive 14, instruction information for formatting the ratio between the size of the data partition DP and the size of the reference partition RP in the magnetic tape T to the second ratio calculated by the calculation unit 42. Thereby, the controller 16 formats the magnetic tape T such that the ratio between the size of the data partition DP and the size of the reference partition RP in the magnetic tape T is set to the second ratio calculated by the calculation unit 42.

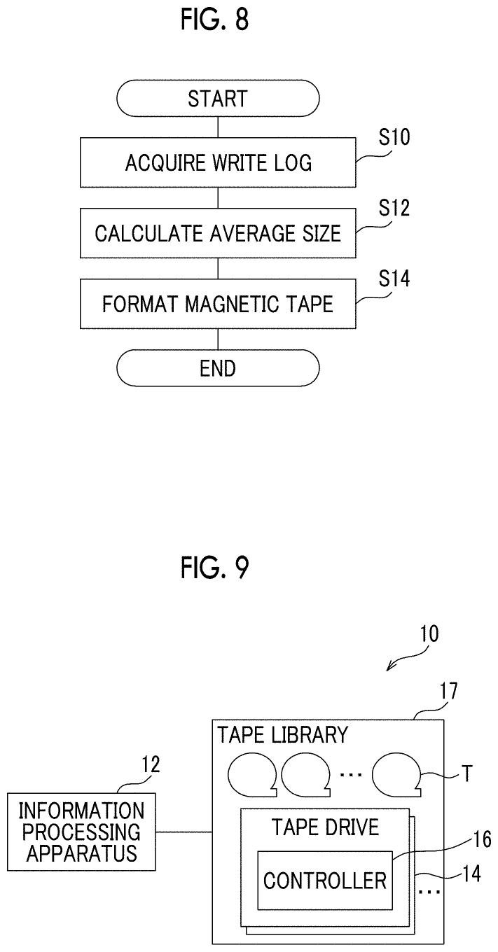

Next, an operation of the information processing apparatus 12 according to the present embodiment will be described with reference to FIG. 8. In a case where the CPU 20 executes the information processing program 30, format processing of the magnetic tape T illustrated in FIG. 8 is executed. The format processing of the magnetic tape T illustrated in FIG. 8 is executed, for example, in a case where an execution instruction is input by the user via the input unit 24.

In step S10 of FIG. 8, the acquisition unit 40 acquires the write log 32 from the storage unit 22. In step S12, the calculation unit 42 calculates the average size A of the objects and the average size B of pieces of the metadata, from the write log 32 acquired in step S10. Further, as described above, the calculation unit 42 calculates the second ratio by using the first ratio as a ratio between the calculated average size A and the calculated average size B.

In step S14, as described above, the controller 44 performs control of setting the ratio between the size of the data partition DP and the size of the reference partition RP in the magnetic tape T included in the tape drive 14 to the second ratio calculated by the calculation unit 42. In a case where processing of step S14 is completed, format processing of the magnetic tape is completed.

As described above, according to the present embodiment, the second ratio as a ratio between the size of the data partition DP and the size of the reference partition RP in the magnetic tape T is calculated by using the first ratio as a ratio between the average size of the objects and the average size of pieces of the metadata. Therefore, the magnetic tape T can be efficiently used.

### Second Embodiment

A second embodiment according to the technique of the present disclosure will be described. In the first embodiment, a case where a tendency between the average size of the objects and the average size of pieces of the metadata in the system can be predicted from the write log 32 has been described. In the present embodiment, an example of an embodiment in which log data corresponding to the write log 32 does not exist at the start of using the system will be described.

First, a configuration of the recording and reproducing system 10 according to the present embodiment will be described with reference to FIG. 9. The same components as components of the recording and reproducing system 10 according to the first embodiment are denoted by the same reference numerals, and a description thereof will be omitted.

As illustrated in FIG. 9, the recording and reproducing system 10 includes an information processing apparatus 12 and a tape library 17. The tape library 17 includes a plurality of slots (not illustrated) and a plurality of tape drives 14, and each slot includes a magnetic tape T.

In a case where the information processing apparatus 12 writes or reads data to or from the magnetic tape T, the magnetic tape T as a write target or a read target is loaded from the slot into a predetermined tape drive 14. In a case where data is written or read to and from the magnetic tape T loaded into the tape drive 14, the magnetic tape T is unloaded from the tape drive 14 into the slot in which the magnetic tape T is originally included.

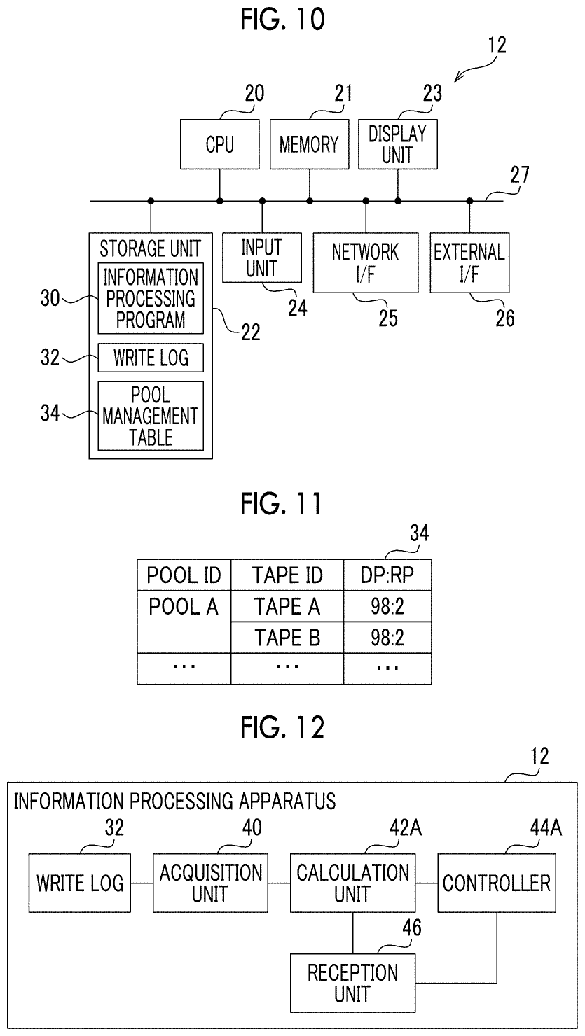

Next, a hardware configuration of the information processing apparatus 12 according to the present embodiment will be described with reference to FIG. 10. The same components as components of the information processing apparatus 12 according to the first embodiment are denoted by the same reference numerals, and a description thereof will be omitted. As illustrated in FIG. 10, an information processing program 30, a write log 32, and a pool management table 34 are stored in the storage unit 22.

The pool management table 34 is a table in which information for managing a storage pool is stored. Here, the storage pool is a pool including a plurality of magnetic tapes T, and has a function of providing a logical volume to be accessed by the information processing apparatus 12 by using a pool ID as identification information of each storage pool. The information processing apparatus 12 accesses the magnetic tape T belonging to the storage pool by accessing the logical volume to which the storage pool is assigned.

FIG. 11 illustrates an example of the pool management table 34. As illustrated in FIG. 11, the pool management table 34 stores, for each storage pool, a pool ID as identification information of the storage pool and a tape ID as identification information of each magnetic tape T belonging to the storage pool. Further, the pool management table 34 stores the ratio between the size of the data partition DP and the size of the reference partition RP in each magnetic tape T.

The write log 32 is not initially stored, and is accumulated in a case where the object is recorded in the magnetic tape T belonging to the storage pool. That is, at an initial stage, in objects to be recorded in the magnetic tape T, a tendency between the average size of the objects and the average size of pieces of the metadata is unknown. In the present embodiment, the magnetic tape T in an initial state is formatted such that the ratio (second ratio) between the size of the data partition DP and the size of the reference partition RP is set to a preset ratio. In the example of FIG. 11, “Tape A” and “Tape B”, which are magnetic tapes Ts belonging to “Pool A” as a pool ID, are formatted such that the ratio between the size of the data partition DP and the size of the reference partition RP is set to 98:2.

Next, a functional configuration of the information processing apparatus 12 according to the present embodiment will be described with reference to FIG. 12. The same functional units as functional units of the information processing apparatus 12 according to the first embodiment are denoted by the same reference numerals, and a description thereof will be omitted. As illustrated in FIG. 12, the information processing apparatus 12 includes an acquisition unit 40, a calculation unit 42A, a controller 44A, and a reception unit 46. In a case where the CPU 20 executes the information processing program 30, the information processing apparatus 12 functions as the acquisition unit 40, the calculation unit 42A, the controller 44A, and the reception unit 46.

For example, in a case where a log when a certain number of objects are recorded in the magnetic tape T is recorded in the write log 32, a pool ID of a storage pool to which a new magnetic tape T is to be added and a tape ID of the magnetic tape T to be added are input by the user via the input unit 24. The reception unit 46 receives the pool ID and the tape ID which are input by the user.

The calculation unit 42A calculates the first ratio from the write log 32 acquired by the acquisition unit 40, similarly to the calculation unit 42 according to the first embodiment. Further, the calculation unit 42A calculates the second ratio in the magnetic tape T to be added to the storage pool such that the second ratio in the entire storage pool having the pool ID received by the reception unit 46 is set to the first ratio.

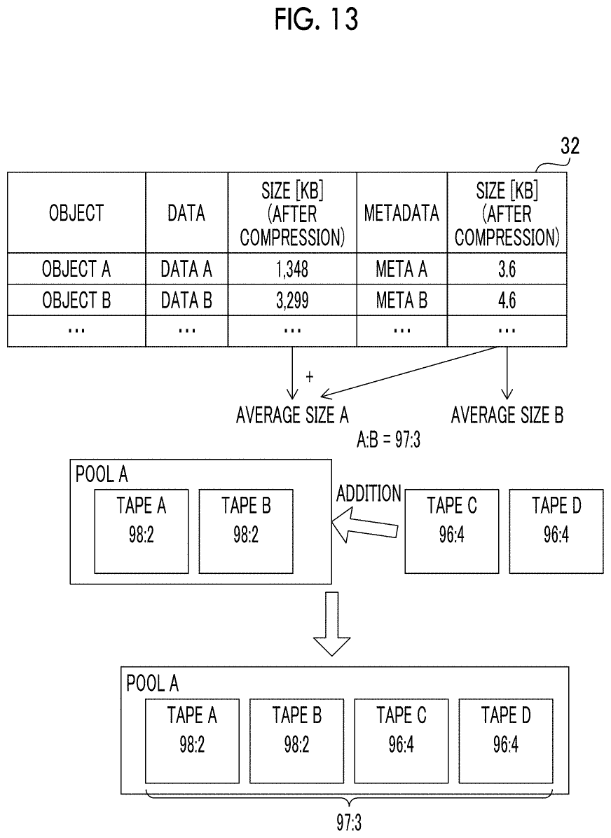

As illustrated in FIG. 13, as a specific example, a case where two magnetic tapes Ts having tape IDs “tape A” and “tape B” belong to a storage pool having a pool ID “pool A” and the second ratio of each of the two magnetic tapes is “98:2” will be described. Further, a case where the first ratio calculated from the write log 32 is “97:3” and two magnetic tapes Ts having tape IDs “tape C” and “tape D” are to be added to a storage pool having a pool ID “pool A” will be described. Further, here, for the sake of simplicity, it is assumed that capacities of the four magnetic tapes Ts having tape IDs “tape A” to “tape D” are the same.

In this case, the second ratio of the entire storage pool having a pool ID “pool A” before addition of the two magnetic tapes Ts is “98:2”. In a case where the second ratio of each of the two magnetic tapes Ts to be added to the storage pool is “96:4”, the second ratio of the entire storage pool after addition of the two magnetic tapes Ts is “97:3” as the calculated first ratio.

Therefore, the calculation unit 42A calculates the second ratio of each of the two magnetic tapes Ts to be added to the storage pool, as “96:4”. In a case where the second ratio of the entire storage pool becomes the first ratio, the second ratios of the two magnetic tapes Ts may not be the same. In a case of the example, for example, the second ratio of one of the two magnetic tapes Ts may be “98:2” and the second ratio of the other of the two magnetic tapes Ts may be “94:6”. Further, the number of the magnetic tapes Ts to be added to the storage pool is not limited to two, and may be one or three or more. Further, capacities of the magnetic tapes Ts belonging to the storage pool may be the same or may be different.

The controller 44A performs control of setting the ratio between the size of the data partition DP and the size of the reference partition RP in the magnetic tape T to be added to the storage pool to the second ratio calculated by the calculation unit 42A. Specifically, the controller 44 outputs, to the controller 16 of the tape drive 14, the tape ID of the magnetic tape T to be added to the storage pool. Further, the controller 44 outputs, to the controller 16 of the tape drive 14, the tape ID and instruction information for formatting the ratio between the size of the data partition DP and the size of the reference partition RP in the magnetic tape T to the second ratio calculated by the calculation unit 42A. Thereby, the controller 16 formats the magnetic tape T such that the ratio between the size of the data partition DP and the size of the reference partition RP in the magnetic tape T having the input tape ID is set to the second ratio calculated by the calculation unit 42A.

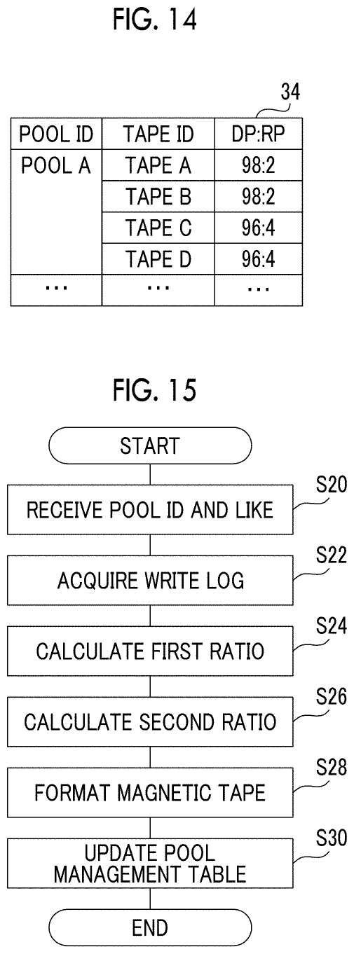

Further, the controller 44A adds information of the magnetic tape T to be added to the storage pool to the pool management table 34. FIG. 14 illustrates an example of the pool management table 34 in which the two magnetic tapes Ts which have tape IDs “tape C” and “tape D” and each of which the second ratio is “96:4” are added to the storage pool having the pool ID “pool A” illustrated in FIG. 11.

Next, an operation of the information processing apparatus 12 according to the present embodiment will be described with reference to FIG. 15. In a case where the CPU 20 executes the information processing program 30, format processing of the magnetic tape T illustrated in FIG. 15 is executed. The format processing of the magnetic tape T illustrated in FIG. 15 is executed, for example, in a case where an execution instruction is input by the user via the input unit 24. At this time, a pool ID of a storage pool to which a new magnetic tape T is to be added and a tape ID of the magnetic tape T to be added are input by the user via the input unit 24.

In step S20 of FIG. 15, the reception unit 46 receives the pool ID and the tape ID which are input by the user. In step S22, the acquisition unit 40 acquires the write log 32 from the storage unit 22. In step S24, the calculation unit 42A calculates a first ratio as a ratio between the average size A of the objects and the average size B of pieces of the metadata, from the write log 32 acquired in step S22.

In step S26, as described above, the calculation unit 42A calculates the second ratio of the magnetic tape T to be added to the storage pool such that the second ratio of the entire storage pool having the pool ID received in step S20 is set to the first ratio calculated in step S24. In step S28, as described above, the controller 44A performs control of setting the ratio between the size of the data partition DP and the size of the reference partition RP in the magnetic tape T to be added to the storage pool to the second ratio calculated in step S26.

In step S30, as described above, the controller 44A adds information of the magnetic tape T to be added to the storage pool to the pool management table 34. In a case where processing of step S30 is completed, format processing of the magnetic tape T is completed.

Processing of recording an object in the storage pool to which the magnetic tape T formatted as described above belongs will be described. In this case, the controller 44A performs control of selecting, from the storage pool, a magnetic tape T according to the first ratio of the objects as recording targets and recording an object in the selected magnetic tape T.

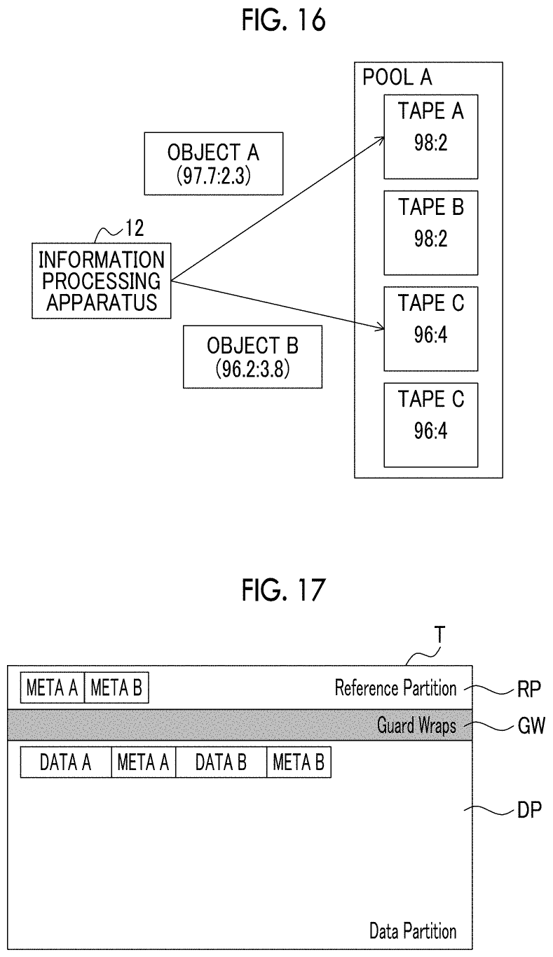

Specifically, for example, as illustrated in FIG. 16, the controller 44A performs control of selecting, among the plurality of magnetic tapes T included in the storage pool, one magnetic tape T of which the second ratio is closest to the first ratio of the objects as recording targets and recording an object in the selected magnetic tape T. At this time, the controller 44A performs control of recording an object in the data partition DP of the selected magnetic tape T and recording metadata included in the object in the reference partition RP. In FIG. 16, the ratio of the objects in parentheses represents the first ratio of the objects, and the ratio in the magnetic tape T in parentheses represents the second ratio in the magnetic tape T. The controller 44A may estimate a ratio between a usage rate of the data partition DP after recording and a usage rate of the reference partition RP after recording in a case where it is assumed that the objects as recording targets are recorded in each magnetic tape T among the plurality of magnetic tapes Ts included in the storage pool. In this case, for example, the controller 44A performs control of selecting one magnetic tape T for which the estimated ratio for each magnetic tape T is closest to the second ratio in each magnetic tape and recording an object in the selected magnetic tape T.

As described above, according to the present embodiment, the same effect as the effect of the first embodiment can be obtained.

In each of the embodiments, the first ratio may be a ratio of the sizes before compression.

Further, in each of the embodiments, in a case where the object including the metadata is recorded in the data partition DP, the metadata may be redundantly recorded.

Further, in each of the embodiments, the calculation unit 42 may classify each object of the write log 32 into a plurality of groups based on the first ratio. A known clustering algorithm such as a k-means method may be used for this classification. In this case, the calculation unit 42 calculates the second ratio by using the first ratio for each classified group. Further, in this case, the controller 44 performs control of setting, for each group, the ratio between the size of the data partition DP and the size of the reference partition RP in the magnetic tape T to the second ratio. In this case, in a case where the objects and pieces of the metadata are recorded in the magnetic tape T formatted according to the second ratio, the objects are classified into one of the plurality of groups, and are recorded in the formatted magnetic tape T in correspondence with the first ratio of the classified group. The calculation by the calculation unit 42 and the control by the controller 44 may be performed in a case where a variance value of the first ratio of each object in the write log 32 is equal to or larger than a predetermined threshold value.

Further, in each of the embodiments, in a case where the information processing apparatus 12 records the object in the data partition DP of the magnetic tape T, a case where the object is recorded in order of the metadata and the data has been described (refer to FIG. 3). On the other hand, the present disclosure is not limited thereto. For example, as illustrated in FIG. 17, in a case where the information processing apparatus 12 records the object in the data partition DP of the magnetic tape T, the object may be recorded in order of the data and the metadata.

Further, in each of the embodiments, for example, as a hardware structure of a processing unit that executes various processing such as the acquisition unit 40, the calculation units 42 and 42A, the controllers 44 and 44A, and the reception unit 46, the following various processors may be used. The various processors include, as described above, a CPU which is a general-purpose processor that functions as various processing units by executing software (program), and a dedicated electric circuit which is a processor having a circuit configuration specifically designed to execute specific processing, such as a programmable logic device (PLD) or an application specific integrated circuit (ASIC) that is a processor of which the circuit configuration may be changed after manufacturing such as a field programmable gate array (FPGA).

One processing unit may be configured by one of these various processors, or may be configured by a combination of two or more processors of the same type or different types (for example, a combination of a plurality of FPGAs or a combination of a CPU and an FPGA). Further, the plurality of processing units may be configured by one processor.

As an example in which the plurality of processing units are configured by one processor, firstly, as represented by a computer such as a client and a server, a form in which one processor is configured by a combination of one or more CPUs and software and the processor functions as the plurality of processing units may be adopted. Secondly, as represented by a system on chip (SoC) or the like, a form in which a processor that realizes the function of the entire system including the plurality of processing units by one integrated circuit (IC) chip is used may be adopted. As described above, the various processing units are configured by using one or more various processors as a hardware structure.

Further, as the hardware structure of the various processors, more specifically, an electric circuit (circuitry) in which circuit elements such as semiconductor elements are combined may be used.

Further, in each of the embodiments, an example in which the information processing program 30 is stored (installed) in the storage unit 22 in advance has been described. On the other hand, the present disclosure is not limited thereto. The information processing program 30 may be provided by being recorded in a recording medium such as a compact disc read only memory (CD-ROM), a digital versatile disc read only memory (DVD-ROM), or a Universal Serial Bus (USB) memory. Further, the information processing program 30 may be downloaded from an external apparatus via a network.

In the disclosure of Japanese Patent Application No. 2020-034302, filed Feb. 28, 2020, the entire contents of which are incorporated herein by reference. Further, all documents, patent applications, and technical standards mentioned in this specification are incorporated herein by reference to the same extent as in a case where each document, each patent application, and each technical standard are specifically and individually described by being incorporated by reference.

What is claimed is:

1. An information processing apparatus comprising:
at least one processor,
wherein the processor is configured to, in a case where an object including at least one of data or metadata related to the data is recorded in a magnetic tape including a first partition in which one or more objects are to be recorded and a second partition in which pieces of the metadata are to be recorded, calculate a second ratio as a ratio between a size of the first partition and a size of the second partition in the magnetic tape by using a first ratio as a ratio between a total size of the objects and a total size of the pieces of the metadata.

2. The information processing apparatus according to claim 1,
wherein the first ratio is a ratio between the total size of the objects after compression and the total size of the pieces of the metadata after compression.

3. The information processing apparatus according to claim 1,
wherein the processor is configured to, in a case where one storage pool includes a plurality of the magnetic tapes, calculate the second ratio in the magnetic tape to be added to the storage pool such that the second ratio in the entire storage pool is set to the first ratio.

4. The information processing apparatus according to claim 3,
wherein the processor is configured to, in a case where the object is recorded in a storage pool including magnetic tapes formatted according to the second ratio, perform control of selecting one magnetic tape according to the first ratio from the storage pool and recording the object in the selected magnetic tape.

5. The information processing apparatus according to claim 1,
wherein the first ratio is a ratio between an average size of the objects and an average size of the pieces of the metadata, the average sizes being calculated from previous log data.

6. The information processing apparatus according to claim 5,
wherein the average size of the objects and the average size of the pieces of the metadata are average values obtained by weighted averages using weight coefficients having larger values as the object and the metadata are closer to current log data.

7. The information processing apparatus according to claim 1,
wherein the processor is configured to
classify an object group to be recorded in the magnetic tape into a plurality of groups based on the first ratio, and
calculate the second ratio using the first ratio for each classified group.

8. The information processing apparatus according to claim 7,
wherein the processor is configured to
classify the object group into a plurality of groups in a case where a variance value of the first ratio of the object group is equal to or larger than a predetermined threshold value, and
calculate the second ratio using the first ratio for each classified group.

9. The information processing apparatus according to claim 2,
wherein the processor is configured to, in a case where one storage pool includes a plurality of the magnetic tapes, calculate the second ratio in the magnetic tape to be added to the storage pool such that the second ratio in the entire storage pool is set to the first ratio.

10. The information processing apparatus according to claim 9,
wherein the processor is configured to, in a case where the object is recorded in a storage pool including magnetic tapes formatted according to the second ratio, perform control of selecting one magnetic tape according to the first ratio from the storage pool and recording the object in the selected magnetic tape.

11. The information processing apparatus according to claim 2,
wherein the first ratio is a ratio between an average size of the objects and an average size of the pieces of the metadata, the average sizes being calculated from previous log data.

12. The information processing apparatus according to claim 3,
wherein the first ratio is a ratio between an average size of the objects and an average size of the pieces of the metadata, the average sizes being calculated from previous log data.

13. The information processing apparatus according to claim 4,
wherein the first ratio is a ratio between an average size of the objects and an average size of the pieces of the metadata, the average sizes being calculated from previous log data.

14. The information processing apparatus according to claim 9,
wherein the first ratio is a ratio between an average size of the objects and an average size of the pieces of the metadata, the average sizes being calculated from previous log data.

15. The information processing apparatus according to claim 10,
wherein the first ratio is a ratio between an average size of the objects and an average size of the pieces of the metadata, the average sizes being calculated from previous log data.

16. An information processing method executed by a processor of an information processing apparatus, the method comprising:
calculating, in a case where an object including at least one of data or metadata related to the data is recorded in a magnetic tape including a first partition in which one or more objects are to be recorded and a second partition in which pieces of the metadata are to be recorded, a second ratio as a ratio between a size of the first partition and a size of the second partition in the magnetic tape by using a first ratio as a ratio between a total size of the objects and a total size of the pieces of the metadata.

17. A non-transitory computer-readable storage medium storing an information processing program causing a processor of an information processing apparatus to execute a process comprising:
calculating, in a case where an object including at least one of data or metadata related to the data is recorded in a magnetic tape including a first partition in which one or more objects are to be recorded and a second partition in which pieces of the metadata are to be recorded, a second ratio as a ratio between a size of the first partition and a size of the second partition in the magnetic tape by using a first ratio as a ratio between a total size of the objects and a total size of the pieces of the metadata.
